(19) United States
(12) Patent Application Publication
(10) Pub. No.: US 2011/0224039 A1
(43) Pub. Date: Sep. 15, 2011

(54) PROCESS FOR PRODUCING A SLIDING BEARING LOCATION IN A CAST COMPONENT AND CAST COMPONENT ITSELF

(75) Inventors: Michael Huss, Nuernberg (DE); Hermann Stief, Emskirchen (DE); Thomas Kraft, Neuhof/Zenn (DE)

(73) Assignee: SCHAEFFLER KG, Herzogenaurach (DE)

(21) Appl. No.: 12/671,616

(22) PCT Filed: Jul. 3, 2008
(86) PCT No.: PCT/EP2008/058553

§ 371 Date: Feb. 1, 2010

(30) Foreign Application Priority Data
Aug. 2, 2007 (DE) 10 2007 036 442.5

(51) Int. Cl. F16H 7/12; F16C 33/14; F16C 33/06

(52) U.S. Cl. 474/133; 164/47; 384/276

(57) ABSTRACT

A process for producing a sliding bearing bush in a cast component of lightweight metal, preferably a tensioning lever of a belt tensioner. The process includes the following steps: a die, which forms the seat for a sliding bearing bush to be pressed in and has radially outer groove drawing noses, is inserted into a lightweight metal pressure die-casting die. After the liquid lightweight metal has been injected into the lightweight metal pressure die-casting die and subsequently solidified, the die is then drawn out of the lightweight metal pressure die-casting die in such a way that an aperture, which has a groove profile, is formed as a seat for the sliding bearing bush to be pressed in.

### FIELD OF THE INVENTION

The present invention relates to a process for producing a plain bearing location for a cast component made from light metal, preferably a tensioning lever of a belt tensioner, which is usually used in the context of traction mechanisms.

### BACKGROUND OF THE INVENTION

The field in which the present invention is used extends primarily to automotive engineering. By way of example, belt tensioners are used in this field in toothed belt drives. Belt tensioners such as these are mostly fitted to the engine block such that they are pivotable via a tensioning lever. A pressure roller is provided at one end of the tensioning lever. The pressure roller, which is mounted such that it is rotatable about its own axis, applies contact pressure to the toothed belt for tensioning purposes, A tensioning element intended for applying the tensioning force acts on the end of the tensioning lever which is usually opposite. The tensioning element for the most part comprises a mechanical compression spring and/or a hydraulic adjusting unit. DE 197 43 480 A1 discloses such a belt tensioner. In this belt tensioner, use is made of a mechanical/hydraulic tensioning element, the tensioning lever thereof being fitted via a pivot bearing formed in the manner of a plain bearing bush to a support bracket which, by contrast, is fixed in position. The support bracket in turn can be screwed fixedly to the engine block of a vehicle. A distal end of this tensioning lever is provided with a pressure roller which acts on a belt. The tensioning force which acts on the pressure roller in this process is generated by the tensioning element which, on one side, is fastened to the support bracket in a fixed position and, on the other side, acts on the opposite end of the tensioning lever from the pressure roller. A fastening screw screwed into the support bracket extends through the pivot bearing designed as a plain bearing bush on the tensioning lever side, in order to form the pin for the pivot bearing on the support bracket side. The tensioning lever of the belt tensioner is a light metal cast component. The pivot bearing is produced by subjecting the tensioning lever to material-removing machining after the casting, in which a passage bore, inter alia, is also produced as a seat for a plain bearing. This material-removing machining step is therefore necessary since, to date, it has not been possible to produce such cylindrical bores by casting with a high degree of accuracy. On the other hand, material-removing machining requires a correspondingly high expenditure in manufacturing.

### OBJECT OF THE INVENTION

Therefore, the object of the present invention is to improve the production of cast components equipped with plain bearing locations, in particular tensioning levers of belt tensioners, such that simplified production in terms of manufacturing is possible.

### SUMMARY OF THE INVENTION

The object is achieved on the basis of a process according to the preamble of claim 1, in conjunction with the characterizing features of said claim. With respect to a cast component as such, the object is achieved by claim 5. The dependent claims which refer back to each of these claims define advantageous developments of the invention.

The invention encompasses the teaching, with respect to the process, that a ram which forms the seat for a plain bearing bush to be pressed in and has radially outer groove drawing noses, is inserted into the light metal diecasting die as early as during the diecasting process step. After the liquid light metal has been injected into the light metal diecasting die and subsequently solidified, the ram is drawn out of the light metal diecasting die in such a way that an aperture provided with the groove profile is formed as the seat for the plain bearing bush to be pressed in.

The advantage of the solution according to the invention is, in particular, that material-removing finishing of the cast part can be dispensed with completely for producing the plain bearing location. More modern die technology makes it possible to provide rams for light metal diecasting dies which consist of specially coated high-grade steels which can preferably form, with the aid of a high-performance lubricating and parting agent, an approximately cylindrical bore, the draft angle of which virtually reaches 0°. Since a purely cylindrical ram does not provide the tolerance needed to press in a corresponding plain bearing, the solution according to the invention comprises the further measure that the ram used has a very special design, i.e. is provided with so-called groove drawing noses. Groove drawing noses are integral formations on the outer surface of the ram, which has a cylindrical base cross section, and are in the form of noses in the longitudinal direction of the ram in order to produce channels in the surrounding material as the ram is drawn out of the material.

The aperture produced in this way should be recalibrated to a higher dimensional stability during a subsequent calibration step. A calibration mandrel made from ground tool steel and having a conical entry slope is preferably used for the calibration and, as a result of being pushed into the aperture, widens the latter and thus brings it to finished size. This finishing step can be carried out in conjunction with punch deburring, which is also conventional, in a production stage during which the cast part is still so warm that it can easily be deformed. Calibration and punch deburring in one finishing step are also effective non-material-removing machining steps.

The groove profile of the aperture should preferably have a plurality of equidistant drawing grooves which are arranged parallel to each other. During casting, an aperture similar to a cylinder is therefore formed, the drawing grooves formed thereon not being filled completely so as to form the required free space for holding substances for the subsequent calibration process.

For this purpose, it is preferably sufficient if the width of the drawing grooves is less than the spacing between adjacent drawing grooves. This preferred design embodiment achieves firstly an optimum in terms of the minimum available free space and secondly maximum stability of the press-in seat for the plain bearing bush.

### BRIEF DESCRIPTION OF THE DRAWINGS

Further measures which improve the invention are explained in more detail below together with the description of a preferred exemplary embodiment of the invention and with reference to the figures.

FIG. 1 shows a partial sectional side view of a belt tensioner;

FIG. 2 shows a top view of the belt tensioner shown in FIG. 1;

FIG. 3 shows a partial section of the tensioning lever in the region of the plain bearing; and

FIG. 4 shows a top view of the plain bearing shown in FIG. 3.

### DETAILED DESCRIPTION OF THE DRAWINGS

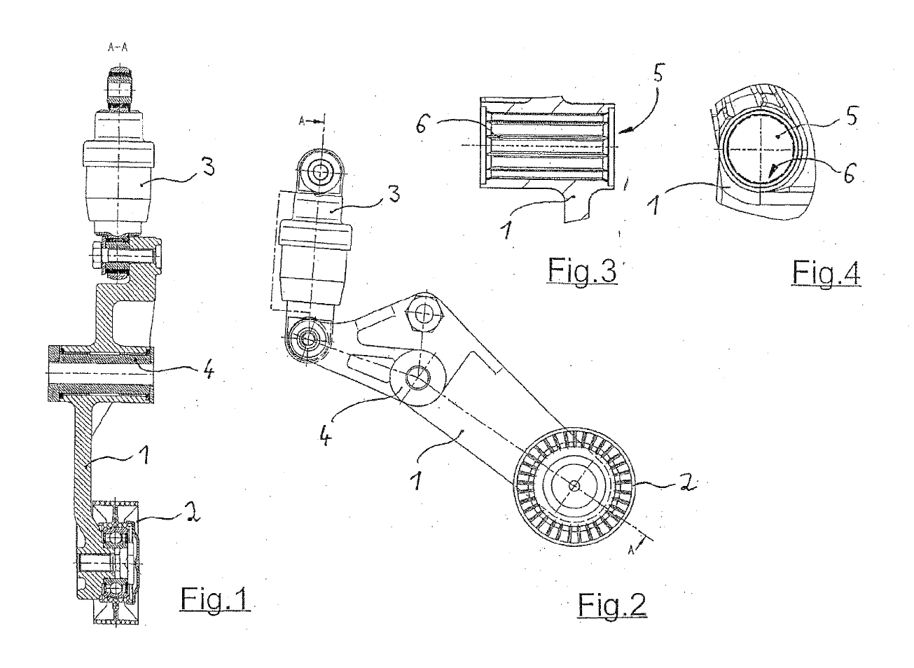

According to FIG. 1, the belt tensioner for traction mechanisms comprises a tensioning lever 1 which is made from cast aluminum and, at one end, is equipped with a pressure roller 2 which is fitted at said end in a rotatable manner and presses on a toothed belt (not shown in greater detail here) of a traction mechanism. A mechanical-hydraulic actuating element 3 is coupled to the opposite end of the tensioning lever 1 and, at one end, is supported in a fixed position on the engine block (not shown in greater detail) of a motor vehicle and, at the opposite end, is coupled to the tensioning lever 1. The central region of the tensioning lever 1 is provided with a pressed-in plain bearing bush 4 which forms a pivot bearing relative to the engine block.

According to FIG. 2, the plain bearing bush 4 is arranged approximately on a line between the coupling point of the mechanical-hydraulic actuating element 3 and the pressure roller 2, to be precise much closer to the coupling point of the mechanical-hydraulic actuating element.

According to FIG. 3, the tensioning lever 2 is formed with a grooved aperture 5 as a seat for the plain bearing bush 4 (not visible in this illustration) which is to be pressed in here. This aperture 5 provided with a groove profile is produced by a ram which is provided with radially outer groove drawing noses being inserted into a light metal diecasting die, and, after the liquid light metal has been injected and subsequently solidified, said ram being drawn out of the light metal diecasting die in such a way as to form the grooved aperture 5.

The groove profile of the aperture 5 comprises a plurality of individual equidistant drawing grooves 6 which are arranged parallel to each other.

According to FIG. 4, the width of these drawing grooves 6 is less than the spacing between adjacent drawing grooves 6.

The implementation of the invention is not restricted to the above-described preferred exemplary embodiment which merely represents a possible application within the context of a belt tensioner for a traction mechanism of a motor vehicle. Rather, modifications within the context of other applications which are covered by the scope of protection of the claims which follow are also conceivable. By way of example, it is thus also possible to use the process according to the invention to produce a plain bearing bush for a cast component on aluminum tensioning rails for chain drives and the like.

### LIST OF REFERENCE SIGNS

1 Tensioning lever
2 Pressure roller
3 Mechanical-hydraulic actuating element
4 Plain bearing bush
5 Aperture
6 Drawing groove

1. A process for producing a plain bearing bush for a cast component made from light metal, preferably a tensioning lever of a belt tensioner, comprising the following steps:
inserting a ram, which forms a seal for a plain bearing bush to be pressed in and has radially outer groove drawing noses, into a light metal diecasting die; and
after the light metal has been injected into the light metal diecasting die and subsequently solidified, the ram is drawn out of the lightweight metal diecasting die in such a way that an aperture provided with a groove profile is formed as the seat for the plain bearing bush to be pressed in.

2. The process of claim 1, wherein, after the ram has been drawn, dimensional stability of the aperture is increased by using an additional calibration tool.

3. The process of claim 1, wherein, before the light metal is injected, the ram is provided with a high-performance lubricating and parting agent.

4. The process of claim 3, wherein a calibration tool is used at the same time as the cast component is being subjected to a punch deburring step.

5. A cast component made from light metal having at least one pressed-in plain bearing bush which is produced by the process of claim 1.

6. The cast component of claim 5, wherein the groove profile of the aperture has a plurality of equidistant drawing grooves which are arranged parallel to each other.

7. The cast component of claim 6, wherein a width of the drawing grooves is less than a spacing between adjacent drawing grooves.

8. A belt tensioner for traction mechanisms having a tensioning lever which is in the form of a cast component of claim 5.
